(19) United States
(12) Patent Application Publication
(10) Pub. No.: US 2016/0290866 A1
(43) Pub. Date: Oct. 6, 2016

(54) APPARATUS AND METHOD FOR MEASURING FLUORESCENCE OF A SAMPLE

(71) Applicant: DeNovix, Inc., Wilmington, DE (US)

(72) Inventors: Fernando F. Kielhorn, Wilmington, DE (US); David B. Ward, Downington, PA (US); David L. Ash, Hockessin, DE (US)

(21) Appl. No.: 15/085,520

(22) Filed: Mar. 30, 2016

Related U.S. Application Data
(60) Provisional application No. 62/140,196, filed on Mar. 30, 2015.

(51) Int. Cl. G01J 3/44; G01N 21/25; G01N 21/64

(52) U.S. Cl. CPC G01J 3/4406; G01N 21/645; G01N 21/255; G01N 2201/062

(57) ABSTRACT

An apparatus and method for measuring fluorescence of a sample is described. An apparatus includes three or more fluorescence channels passing through a sample site. The three or more fluorescence channels allow for exposing a sample at the sample site to light from three or more light sources, which results in fluorescence measurements based on emissions from the sample in response to the three or more light sources.

### CROSS-REFERENCE TO RELATED APPLICATION

This application claims the benefit of U.S. Provisional Application No. 62/140,196, entitled, “APPARATUS AND METHOD FOR MEASURING FLUORESCENCE OF A SAMPLE,” filed Mar. 30, 2015, which is hereby incorporated by reference herein in its entirety, including drawings.

### BACKGROUND

1. Field

Embodiments of the claimed invention relate to optical measurements and, in particular, an apparatus and method for measuring fluorescence of a sample.

2. Description of Related Art

A fluorometer is an instrument used to measure parameters of fluorescence of a sample. These parameters and the associated measurements can be used for a variety of purposes, such as to identify the presence and amount of materials within the sample. A fluorometer contains a light source that emits light. The light contacts the sample, which excites electrons in certain materials within the sample, also known as fluorophores, and causes the materials to emit light (light emission) in the form of fluorescence.

A filter fluorometer is a specific type of fluorometer. In a filter fluorometer, the light source emits light of an excitation wavelength that is relevant to the sampled material. A detector then detects the light emission from the sample upon the sample being exposed to the light. An excitation filter within the filter fluorometer permits only selected wavelengths of light to pass from the light source and to the sample. An emission (barrier) filter permits only selected wavelengths of the light emission from the sample to pass through towards the detector.

Light from the light source travels down a first channel to the sample, and light emission from the sample travels down a second channel to the detector. The first channel and the second channel are typically orthogonal to each other and connect at a sample site that holds the sample. Together, the first channel and the second channel form a fluorescence channel.

Conventionally, a filter fluorometer includes two light sources and two detectors for a single sample site. Accordingly, each pair of light source and detector corresponds to a fluorescence channel that is formed of a pair of channels at right angles. The combined pairs of light sources and detectors, with their corresponding fluorescence channels, form the shape of a cross or an X.

Limitations in manufacturing fluorometers limit the number of fluorescence channels and, consequently, pairs of light sources and detectors, to two for each fluorometer. This limits the capabilities of the fluorometer.

A need exists, therefore, for fluorometers that include more than two fluorescence channels, to improve the performance and efficiency of fluorometers. A need also exists for a compact fluorometer that includes more than two pairs of light sources and detectors that can be combined with, for example, existing spectrophotometers, for more robust performance and functionality within a single system or device.

### SUMMARY OF THE INVENTION

In view of the foregoing, one aspect of the present disclosure provides for an apparatus for measuring fluorescence that includes three or more light source and detector pairs, and three or more corresponding fluorescence channels. According to one embodiment, the apparatus includes a housing that holds a sample that includes three or more channels directed to the sample from three or more light sources. The housing also includes three or more channels directed away from the sample to three or more detectors. Pairs of channels connect at right angles to optically connect light sources with corresponding detectors, with the sample positioned at the point where the channels connect. Such an apparatus allows for three or more light sources for measuring the fluorescence of a sample.

According to some aspects of the present disclosure, the above apparatus can be a standalone apparatus for measuring the fluorescence of a sample. According to additional aspects of the present disclosure, the above apparatus can be configured to connect to an additional apparatus, such as a spectrophotometer, for combining the fluorescence measurements of a sample with spectrophotometry measurements of the same sample, or of an additional sample, within a single system. According to still additional aspects of the present disclosure, the above apparatus can be integrated into an additional apparatus, such as a spectrophotometer, for combining fluorescence measurements of a sample with spectrophotometry measurements of the same sample, or of an additional sample, within a single apparatus.

According to some aspects, an apparatus for measuring fluorescence of a sample includes at least three light sources, at least three light detectors, and a sub-housing comprising. The sub-housing includes a sample site that accepts the sample and three fluorescence channels. A first fluorescence channel has a first incoming light channel and a first outgoing light channel intersecting at the sample site. The first incoming light channel is aligned with a first light source of the at least three light sources, and the first outgoing light channel is aligned with a first light detector of the at least three light detectors. A second fluorescence channel has a second incoming light channel and a second outgoing light channel intersecting at the sample site. The second incoming light channel is aligned with a second light source of the at least three light sources, and the second outgoing light channel is aligned with a second light detector of the at least three light detectors. A third fluorescence channel has a third incoming light channel and a third outgoing light channel intersecting at the sample site. The third incoming light channel is aligned with a third light source of the at least three light sources, and the third outgoing light channel is aligned with a third light detector of the at least three light detectors.

According to the present concepts, an apparatus for performing spectrophotometry and fluorescence measurements on one or more samples includes a first sample site positioned along a spectrophotometry light channel for performing the spectrophotometry measurements on a first sample, a second sample site for performing the fluorescence measurements on a second sample, and a sub-housing at least partially surrounding the second sample site. The sub-housing includes at least three fluorescence channels aligned with the second sample site for performing at least three fluorescence measurements of at least three different wavelengths of light on the second sample. Each fluorescence channel includes an incoming light channel and an outgoing light channel orthogonal to the incoming light channel at the second sample site.

According to additional aspects, a method of measuring the fluorescence of a sample is disclosed. The method includes transmitting light from a first light source down a first incoming light channel of an apparatus toward the sample, transmitting light from a second light source down a second incoming light channel of the apparatus toward the sample, and transmitting light from a third light source down a third incoming light channel of the apparatus toward the sample. The method further includes measuring light emitted from the sample down a first outgoing light channel in response to the light from the first light source, measuring light emitted from the sample down a second outgoing light channel in response to the light from the second light source, and measuring light emitted from the sample down a third outgoing light channel in response to the light from the third light source.

Still other aspects, features, and advantages of the present invention are readily apparent from the following detailed description, simply by illustrating a number of exemplary embodiments and implementations, including the best mode contemplated for carrying out the present invention. The present invention also is capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1A shows a perspective view of an apparatus for measuring the fluorescence of a sample, in accord with aspects of the present concepts.

FIG. 1B shows a perspective view of an apparatus for measuring the fluorescence of a sample, in accord with additional aspects of the present concepts.

FIG. 1C shows a perspective view of a system for measuring the fluorescence of a sample, in accord with additional aspects of the present concepts.

FIG. 2A shows a perspective view of a housing for positioning a sample relative to three or more light sources and detectors, in accord with aspects of the present concepts.

FIG. 2B shows another perspective view of the housing of FIG. 2A, in accord with aspects of the present concepts.

FIG. 2C shows a side view of the puck of the housing of FIG. 2A, in accord with aspects of the present concepts.

FIG. 2D shows a cross-section of the puck of FIG. 2A along the line 2D-2D in FIG. 2C, in accord with aspects of the present concepts.

FIG. 2E shows a cross-section of the puck of FIG. 2A along the line 2E-2E in FIG. 2B, in accord with aspects of the present concepts.

FIG. 2F shows a bottom view of the puck of FIG. 2A, in accord with aspects of the present concepts.

FIG. 2G shows a top view of the puck of FIG. 2A, in accord with aspects of the present concepts.

FIG. 2H shows a perspective view of only the puck of the housing of FIG. 2A, in accord with aspects of the present concepts.

FIG. 2I shows a perspective view of only the ring of the housing of FIG. 2A, in accord with aspects of the present concepts.

### DETAILED DESCRIPTION

An apparatus and method for measuring the fluorescence of a sample is described. In the following description, for purposes of explanation, numerous specific details are set forth in order to provide a thorough understanding of the exemplary embodiments. It is apparent to one skilled in the art, however, that the present invention can be practiced without these specific details or with an equivalent arrangement.

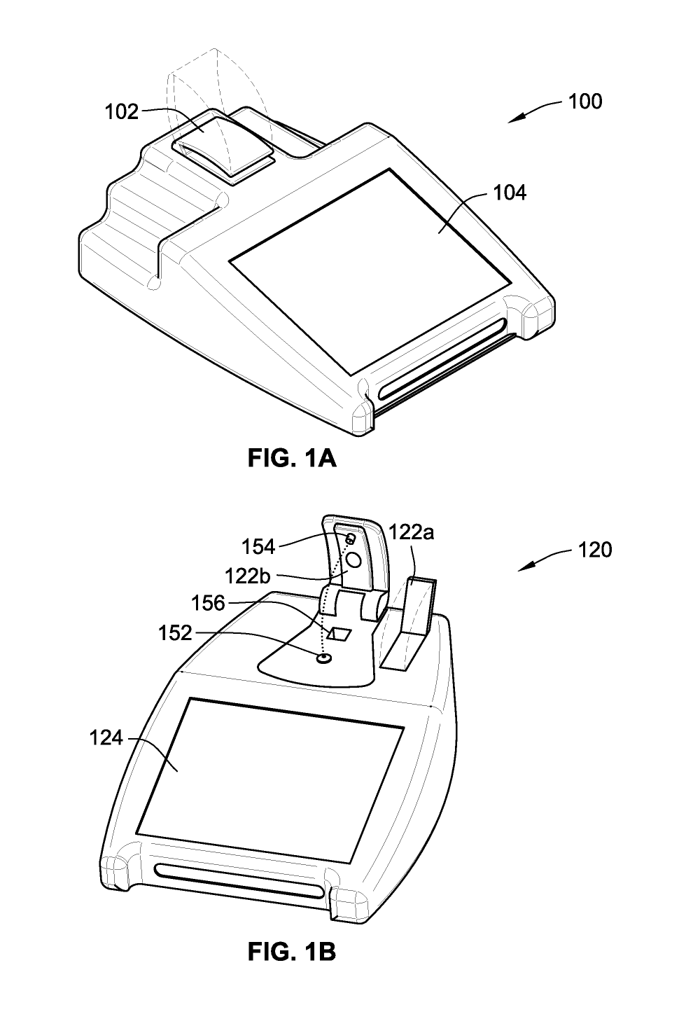

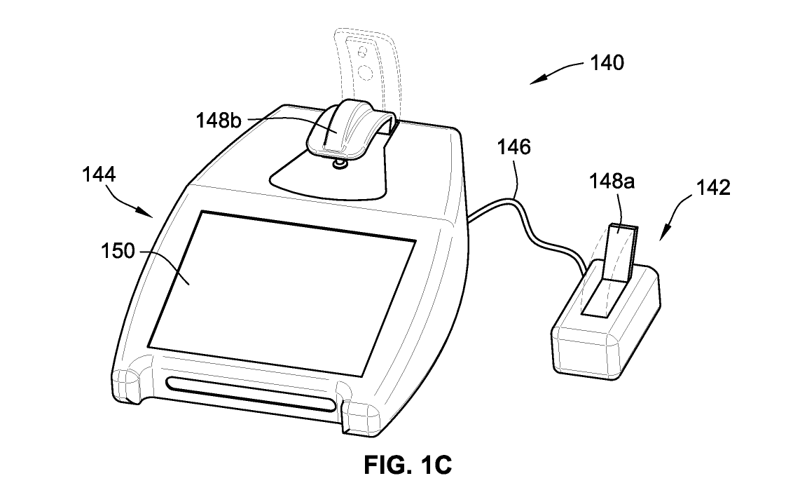

Referring now to the drawings, wherein like reference numerals designate identical or corresponding parts throughout the several views, FIG. 1A shows a perspective view of an apparatus 100 for measuring the fluorescence of a sample, in accord with aspects of the present concepts. The apparatus 100 is a standalone apparatus that provides only fluorescence measurements, as opposed to other optical measurements. The apparatus 100 includes a latch 102 (shown in a closed position) that opens and closes to insert a sample into a sample site beneath the latch 102. The sample site can accept various containers that hold the sample, such as a PCR tube.

As will be described in greater detail below, with the sample inserted into the sample site, the apparatus 100 measures the fluorescence of the sample by exposing the sample to light from various light sources. More specifically, and for the reasons discussed below, the apparatus 100 includes the capability of having three or more light sources, with three or more corresponding detectors of the resulting emitted light. With the three or more light sources, such as four light sources, the apparatus 100 can provide better measurement of the fluorescence of the sample by exposing the sample to a larger spectrum of light, such as red, blue, green, and ultra-violet light, rather than only, for example, red and blue light.

The apparatus 100 further includes a display 104. The display 104 presents visual representations of the fluorescence measurements of the sample as detected by the apparatus 100. The display 104 also provides a graphical user interface of the apparatus 100 through which a user can operate the apparatus 100. By way of example, and without limitation, the display 104 can be a touchscreen display through which the user can operate the apparatus 100.

The apparatus 100 can further include memory and one or more processors. The memory can store the fluorescence measurements for later reference and/or display. The memory can also store processor-executable instructions for execution by the one or more processors within the apparatus 100 to perform the functionality discussed herein. By way of example, and without limitation, the processor-executable instructions can cause the apparatus 100 to operate the light sources and the detectors to measure the fluorescence of the sample. Specifically, the processor-executable instructions can cause the one or more processors to, for example, cause the light sources to emit light towards a sample site, cause light detectors to detect light emissions from the sample site, specifically a sample at the sample site, and perform one or more algorithms for the analysis of the detected light emissions. According to some embodiments, the samples can be various fluorescence assays, such as various commercially available fluorescence assay kits. Further, the processor-executable instructions can include software that a user can customize for analyzing customized fluorophores.

FIG. 1B shows a perspective view of an apparatus 120 for measuring the fluorescence of a sample, in accord with additional aspects of the present concepts. The apparatus 120 is a combined spectrophotometer and fluorometer. Accordingly, the apparatus 120 includes a latch 122a (shown in an open position) and a latch 122b (shown in an open position). The latch 122a opens and closes to allow the insertion of a first sample into a first sample site for fluorescence measurements of the first sample. The latch 122b opens and closes for placing a second sample into and/or onto a second sample site for spectrophotometry measurements of the second sample. By way of example, and without limitation, the first sample can be contained in a PCR tube that is inserted into the first sample site below the latch 122a. The second sample can be contained in a cuvette or similar container for spectrophotometry measurements. The cuvette can be inserted into the second sample site, which can be the port 156 that is configured to accept the cuvette (or similar container) below the latch 122b. Alternatively, the latch 122b can open and close between two sample surfaces for spectrophotometry measurements of a microvolume sample. The second sample site can include the sample surface 154, which can be fixed to and movable with the bottom of the latch 122b, and the sample surface 152, which can be stationary and fixed to the main body of the apparatus 120. In this aspect, the second sample can be a microvolume sample that is placed between the sample surfaces 152 and 154. Alternatively, in some aspects, the apparatus 120 can include both the sample surfaces 152 and 154, for microvolume samples, and the port 156, for samples contained in a cuvette or a similar container. In such a configuration, the apparatus 120 includes three sample sites, the first sample site for fluorescence measurements below the latch 122a, the second sample site of the port 156 below the latch 122b, and the third sample site of the sample surfaces 152 and 154 for microvolume samples.

Similar to the apparatus 100, with the first sample inserted into the first sample site, the apparatus 120 is able to measure the fluorescence of the first sample by exposing the first sample to light from various light sources. More specifically, and for the reasons discussed below, the apparatus 120 includes the capability of having three or more light sources, with three or more corresponding detectors of resulting emitted light. With the three or more light sources, such as four light sources, the apparatus 120 can provide better sampling of the fluorescence of the first sample by exposing the first sample to a larger spectrum of light, such as red, blue, green, and ultra-violet light, rather than only, for example, red and blue light.

Similar to the apparatus 100, the apparatus 120 also includes a display 124. The display 124 presents visual representations of the fluorescence measurements of the first sample as detected by the apparatus 120. The display 124 also provides for a graphical user interface of the apparatus 120 through which a user can operate the apparatus 120. By way of example, and without limitation, the display 124 can be a touchscreen display through which the user can operate the apparatus 120.

The apparatus 120 can further include memory and one or more processors. The memory can store the measurements for later reference and/or display. The memory can also store processor-executable instructions for execution by the one or more processors within the apparatus 120 to perform the functionality discussed herein. By way of example, and without limitation, the processor-executable instructions can cause the apparatus 120 to operate the light sources and detectors to measure the fluorescence of the first sample, as discussed above. The processor-executable instructions also can cause the one or more processors to operate a light source and corresponding detector to perform the spectrophotometry measurements of the second sample. According to some embodiments, the first sample can be various fluorescence assays, such as various commercially available fluorescence assay kits. Further, the processor-executable instructions can include software that a user can customize for analyzing customized fluorophores. Accordingly, the apparatus 120 provides a compact platform to perform fluorescence measurements on a sample using three or more light sources (e.g., four, five, six, or more light sources), in addition to performing spectrophotometry measurements at one or more additional sample sites on one or more additional samples.

FIG. 1C shows a perspective view of a system 140 for measuring the fluorescence of a sample, in accord with additional aspects of the present concepts. The system 140 includes a standalone fluorometer 142 and a standalone spectrophotometer 144. The fluorometer 142 includes a cable 146 that electrically connects the fluorometer 142 to the spectrophotometer 144. By way of example, and without limitation, the spectrophotometer 144 can include one or more connectors or ports, such as a Universal Serial Bus (USB), a serial port, a parallel port, etc., that allow the fluorometer 142 to connect to the spectrophotometer 144 and communicate information between both devices. The cable 146 allows the fluorometer 142 to share data with the spectrophotometer 144, such as fluorescence measurements generated by the fluorometer 142.

Similar to the apparatus 120, the fluorometer 142 includes a latch 148a (shown in an open position) and the spectrophotometer 144 includes a latch 148b (shown in a closed position). The latch 148a opens and closes to allow the insertion of a first sample into a first sample site for measuring fluorescence of the first sample. By way of example, and without limitation, the first sample can be contained in a PCR tube that is inserted into the first sample site. Similarly, the latch 148b opens and closes for placing a second sample into and/or onto a second sample site for spectrophotometry measurements of the second sample. By way of example, and without limitation, the second sample can be contained in a cuvette or similar container for spectrophotometry measurements, and the cuvette can be placed in a sample port. Alternatively, as discussed above with respect to the apparatus 120, the second sample site of the spectrophotometer 144 can instead be a pair of sample surfaces. One sample surface can be fixed to the main body of the spectrophotometer 144 and the other sample surface can be fixed to the bottom of the latch 148b and configured to align and interface with the opposite sample surface. Alternatively, the spectrophotometer 144 can include both a sample site that accepts a cuvette or similar container for spectrophotometry measurement of the sample within the container, and a pair of sample surfaces for spectrophotometry measurements of a microvolume sample between the pair of sample surfaces.

Adverting back to the fluorometer 142, with the first sample inserted into the first sample site, the fluorometer 142 is able to measure the fluorescence of the first sample by exposing the first sample to light from various light sources. For the reasons discussed below, the fluorometer 142 includes the capability of having three or more light sources, with three or more corresponding detectors of resulting emitted light. With the three or more light sources, such as four light sources, the fluorometer 142 can provide better sampling of the fluorescence of the first sample by exposing the first sample to a larger spectrum of light. The larger spectrum of light can include, for example, red, blue, green, and ultra-violet light, rather than only, for example, red, and blue light.

Also, similar to the apparatuses 100 and 120, the spectrophotometer 144 includes a display 150. The display 150 presents visual representations of the fluorescence measurements of the first sample from the fluorometer 142 and of the spectrophotometry measurements of the second sample as detected by the spectrophotometer 144. The display 150 also provides for a graphical user interface of the spectrophotometer 144 through which a user can operate the system 140, including the fluorometer 142 and the spectrophotometer 144. By way of example, and without limitation, the display 150 can be a touchscreen display through which the user can operate the system 140.

One or both of the fluorometer 142 and the spectrophotometer 144 can further include memory and one or more processors. The memory can store the measurements for later reference and/or display. The memory can also store processor-executable instructions for execution by the one or more processors within one or both of the fluorometer 142 and the spectrophotometer 144 to perform the functionality discussed herein. By way of example, and without limitation, the processor-executable instructions can cause the system 140 to operate the light sources and detectors to measure the fluorescence of the first sample, as discussed above. According to some embodiments, the first sample can be various fluorescence assays, such as various commercially available fluorescence assay kits. Further, the processor-executable instructions can include software that a user can customize for analyzing customized fluorophores. The processor-executable instructions also can cause the system 140 to operate a light source and detector to perform the spectrophotometry measurements of the second sample.

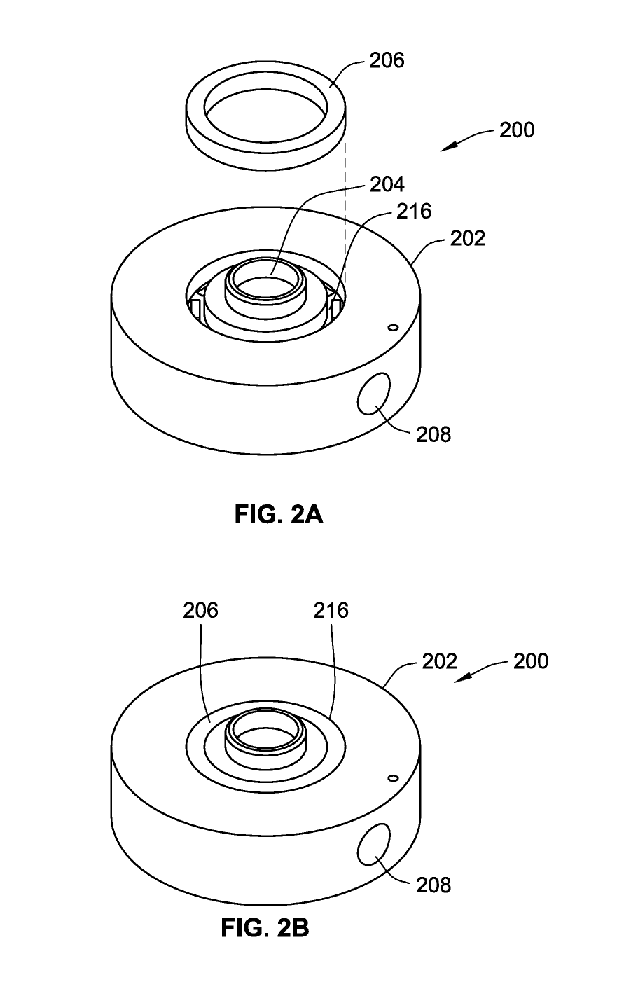

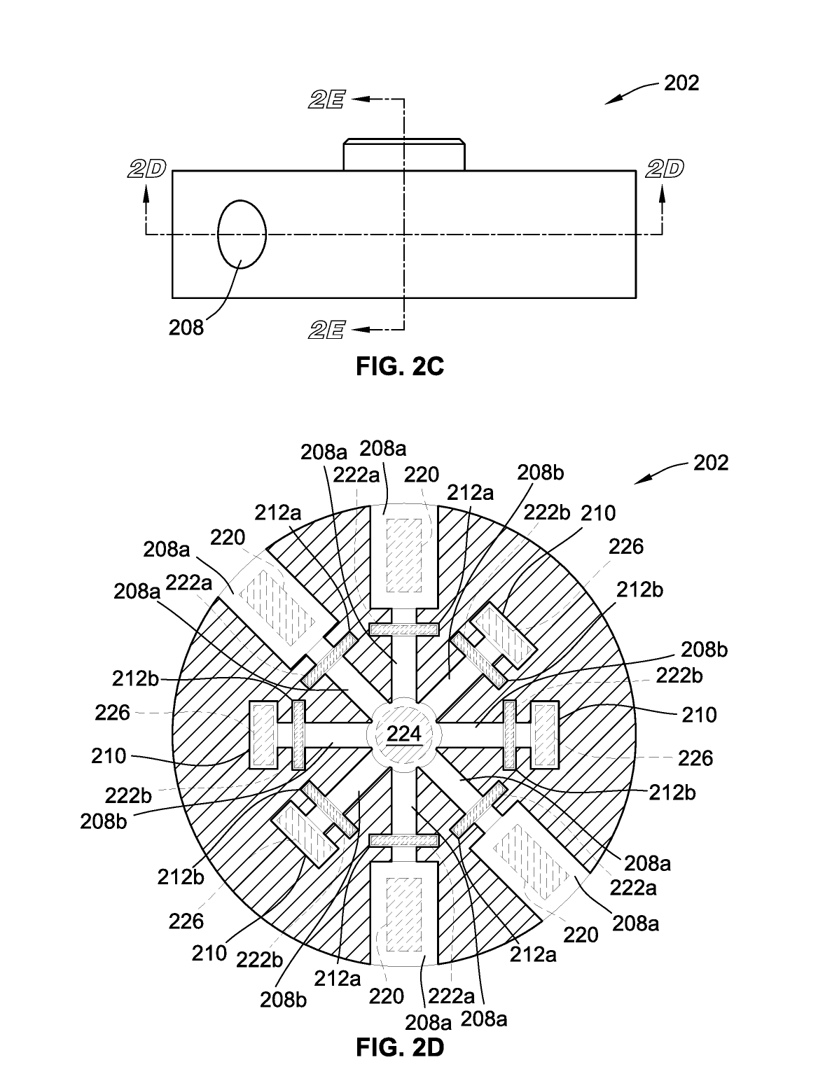

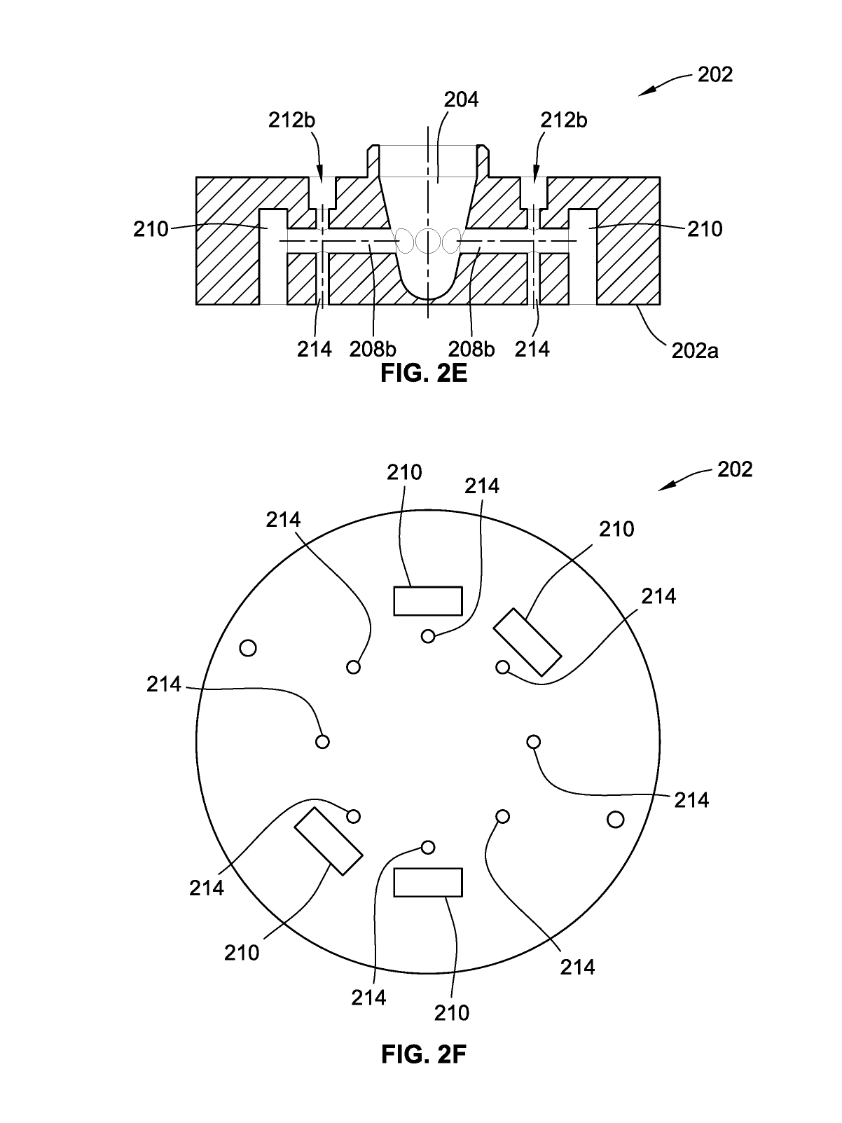

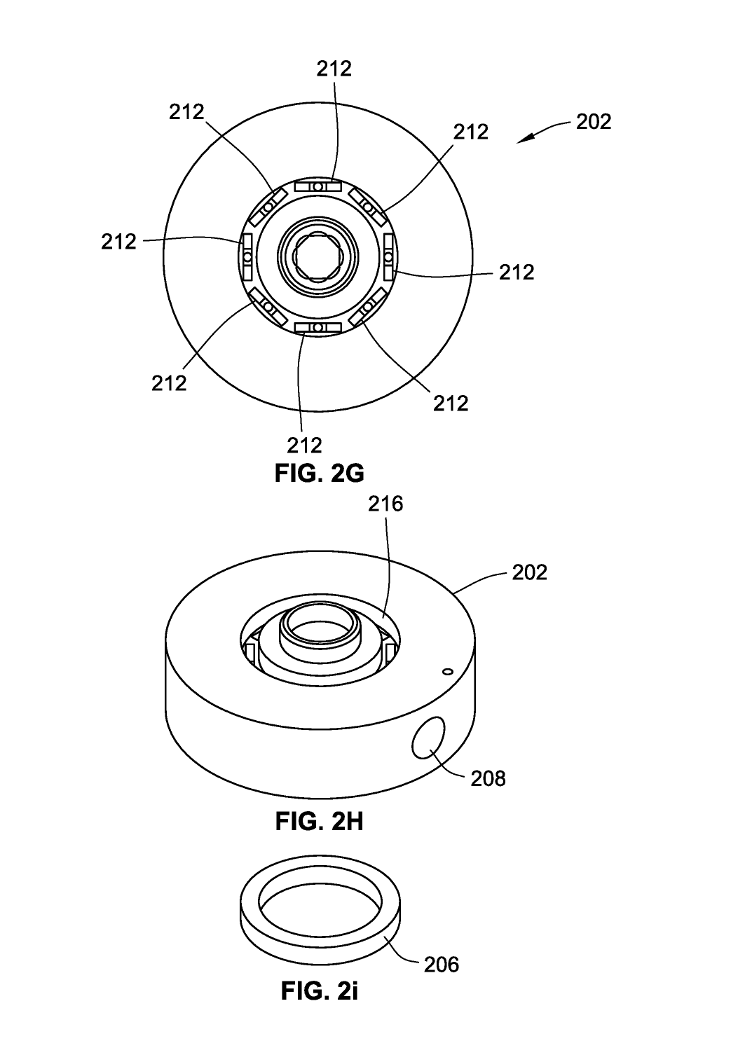

Adverting to FIG. 2A, FIG. 2A shows a perspective view of a housing 200 within a fluorometer (e.g., such as any one of the apparatus 100, the apparatus 120, and the fluorometer 142) for positioning a sample relative to three or more light sources and detectors, in accord with aspects of the present concepts. The housing 200 allows for more versatile fluorescence measurements by exposing a sample, which can contain one or more fluorophores, to three or more light sources.

As shown, the housing 200 includes a sub-housing 202 (also referred to as a puck 202) that accepts a sample within a sample site 204. By way of example, and without limitation, the sample site 204 accepts a PCR tube with the sample inside. However, the sample site 204 can be configured to accept various different containers of the sample. The housing 200 also includes a ring 206 that engages within a recess 216 to secure filters (discussed below) within the puck 202. As shown in FIG. 2A, the ring 206 can be removed from the recess 216 to access the interior of the puck 202. FIG. 2B shows a perspective view of the housing 200, in accord with aspects of the present concepts, with the ring 206 placed within the recess 216. FIG. 2C shows a side view of the puck 202 of FIG. 2A, in accord with aspects of the present concepts. As shown, the puck 202 includes a channel 208 that allows light into (or out of) the puck 202.

FIG. 2D shows the cross-section of the puck 202 along the line 2D-2D within FIG. 2C, in accord with aspects of the present concepts. As shown, the puck 202 includes incoming light channels 208a and outgoing light channels 208b. The incoming light channels 208a and the outgoing light channels 208b can be, for example, 3 millimeters in diameter. However, the size of the incoming light channels 208a and the outgoing light channels 208b can vary without departing from the spirit and scope of the present disclosure. The incoming light channels 208a accept light from separate light sources 220 within the fluorometer. As shown, the light sources 220 can fit within the puck 202, within the larger diameter portions of the incoming light channels 208a near the outer edges of the puck 202. Alternatively, according to some embodiments, the light sources 220 can be within the fluorometer but outside of the puck 202 and positioned to transmit light into and through the incoming light channels 208a. The incoming light channels 208a then pass the light to the sample site 204 that holds the sample 224. The outgoing light channels 208b accept light emissions from the sample 224 and pass the light emissions to detectors 226. The detectors 226 are positioned within detector ports 210 within the puck 202. The incoming light channels 208a are paired with outgoing light channels 208b that are orthogonal to the incoming light channels 208a to form fluorescence channels 208.

Although described as incoming light channels 208a and outgoing light channels 208b, according to some embodiments, the incoming light channels 208a may instead correspond to outgoing light channels that accept light emissions from the sample, and that direct the light emissions to detectors. By way of example, and without limitation, the detectors 226 can be located within the fluorometer but outside of the puck 202. Further, the outgoing light channels 208b may instead correspond to incoming light channels that accept light from light sources 220 and that pass the light to the sample. By way of example, and without limitation, the light sources 220 can instead be located within the detector ports 210 within the puck 202.

The puck 202 further includes filter slots 212. The filter slots 212 accept and position filters 222a and 222b along the incoming and outgoing light channels 208a and 208b. By way of example, and without limitation, the filter slots 212a along the incoming light channels 208a accept excitation filters 222a and the filter slots 212b along the outgoing light channels 208b accept emission filters 222b. With the filters 222a and 222b within the filter slots 212, the ring 206 is secured above the filter slots 212 to secure the filters 222a and 222b within the puck 202.

FIG. 2E shows a cross-section of the puck 202 along the line 2E-2E within FIG. 2C, in accord with aspects of the present concepts. As discussed above, FIG. 2E shows the detector ports 210 that are optically connected to the sample site 204 through outgoing light channels 208b. Along the outgoing light channels 208b are the emission filter slots 212b. The emission filter slots 212b (as well as the excitation filter slots 212a) further include holes 214 that connect to the filter slots 212 from the bottom 202a of the puck 202.

FIG. 2F shows a bottom view of the puck 202 of FIG. 2A, in accord with aspects of the present concepts. As shown, the puck 202 includes the four detector ports 210 and the eight holes 214 corresponding to the locations of the filter slots 212.

FIG. 2G shows a top view of the puck 202 of FIG. 2A, in accord with aspects of the present concepts. The puck 202 includes the eight filter slots 212 for accepting the excitation and emission filters along the incoming and outgoing light channels 208a and 208b.

FIG. 2H shows a perspective view of the puck of FIG. 2A, in accord with aspects of the present concepts. The puck 202 includes the channel 208 (e.g., incoming light channel 208a). FIG. 2H also shows the recess 216 above the filter slots 212 that accepts the ring 206 to secure filters within the filter slots 212. FIG. 2I shows a perspective view of the ring 206 of the housing 200 of FIG. 2A, in accord with aspects of the present concepts.

According to the housing 200 described above and, more particularly, the puck 202 of the housing 200, the puck 202 allows for three or more pairs of light sources and detectors for sampling the fluorescence of a sample. According to a preferred aspect, the puck allows for four pairs of light sources and detectors for sampling the fluorescence of a sample. The light sources can include, for example, four LEDs that each emits one of red, blue, green, or ultra-violet light. Accordingly, unlike conventional fluorometers, a fluorometer (e.g., apparatus 100, apparatus 120, or fluorometer 142) with the puck 202 can include more than two light sources for better sampling of the fluorescence of the sample based on a larger variation in light sources for excitation of the sample. A fluorometer according to the disclosed aspects can include four LEDs, each one emitting light of different wavelengths than the others, that direct light into the puck 202 down respective incoming light channels 208a. The fluorometer can further include four different detectors that are configured to detect the fluorescence emitted from the sample in response to each respective LED. Moreover, each incoming light channel 208a and outgoing light channel 208b can include various filters used in filter fluorescence.

As discussed above, the light sources can be various types of light sources used in measuring the fluorescence of a sample. By way of example, and without limitation, the light sources can be light emitting diodes (LEDs) that emit red, blue, green, or ultra-violet light. However, other types of light sources can be used without departing from the spirit and scope of the present disclosure, such as lasers, xenon arcs, and mercury-vapor lamps. Further, other colors of light can be used without departing from the spirit and scope of the present disclosure, such as yellow light.

For the puck 202 to include three or more fluorescence channels 208, the puck 202 can be formed by three-dimensional (3D) printing. Forming the puck 202 by 3D printing creates a single unitary or monolithic piece. A unitary piece provides more consistency in forming the final product, and can allow for finer tolerances. In contrast, conventional manufacturing methods of sub-housings for fluorometers, such as conventional injection molding, are not viable for creating a puck or similar housing that includes three or more fluorescence channels, particularly when the fluorescence channels are about 3 mm in diameter. Rather, conventional injection molding requires multiple separate pieces that are coupled together as one or more final manufacturing steps. Such final steps can cause, for example, alignment errors that can reduce the amount of light transmitted through the sub-housing. A reduction in the amount of light through the sub-housing can impact measurement performance by reducing the total amount of light that arrives at the detector.

The puck 202 can be formed of any suitable material used in 3D printing, such as thermoplastics, photopolymers, and the like. By forming the puck 202 by 3D printing, a greater number of channels 208 can be formed within the puck 202 for passing and capturing light for the detection of fluorescence, as compared to a conventional housing of a fluorometer that is formed by conventional manufacturing methods.

Adverting back to FIG. 2D, with the puck 202 within a fluorometer, LEDs within the fluorometer, as an example, transmit light of a particular wavelength into the incoming light channels 208a. The light passes through the excitation filters within the filter slots 212a. After passing through the filters, the light illuminates one or more fluorophores of a sample contained in, for example, a PCR tube held in the sample site 204. The light illuminating the one or more fluorophores excites the fluorophores causing the emission of light. The emitted light travels down the outgoing light channels 208b that are perpendicular to the incoming light channels 208a. The emitted light then passes through emission filters within the filter slots 212b along the outgoing light channels 208b. The emitted light not attenuated by the emission filters is then measured by detectors within the detector ports 210. By including three or more fluorescence channels within the puck 202, such as the four fluorescence channels 208, a single fluorometer can provide the ability to measure many more assays that take advantage of the wavelength ranges offered by the additional LED/filter combinations, such as the additional green and ultra-violet wavelengths.

The present invention has been described in relation to particular examples, which are intended in all respects to be illustrative rather than restrictive. Those skilled in the art will appreciate that many different combinations of materials and components will be suitable for practicing the present invention.

Other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

What is claimed is:

1. An apparatus for measuring fluorescence of a sample, the apparatus comprising:
at least three light sources;
at least three light detectors; and
a sub-housing comprising:
a sample site that accepts the sample;
a first fluorescence channel having a first incoming light channel and a first outgoing light channel intersecting at the sample site, the first incoming light channel being aligned with a first light source of the at least three light sources, and the first outgoing light channel being aligned with a first light detector of the at least three light detectors;
a second fluorescence channel having a second incoming light channel and a second outgoing light channel intersecting at the sample site, the second incoming light channel being aligned with a second light source of the at least three light sources, and the second outgoing light channel being aligned with a second light detector of the at least three light detectors; and
a third fluorescence channel having a third incoming light channel and a third outgoing light channel intersecting at the sample site, the third incoming light channel being aligned with a third light source of the at least three light sources, and the third outgoing light channel being aligned with a third light detector of the at least three light detectors.

2. The apparatus of claim 1, wherein the first light source emits one or more red wavelengths of light.

3. The apparatus of claim 2, wherein the second light source emits one or more blue wavelengths of light.

4. The apparatus of claim 3, wherein the third light source emits one or more green wavelengths of light.

5. The apparatus of claim 1, further comprising:
a fourth light source; and
a fourth light detector,
wherein the sub-housing includes a fourth fluorescence channel having a fourth incoming light channel and a fourth outgoing light channel intersecting at the sample site, the fourth incoming light channel being aligned with the fourth light source, and the fourth outgoing light channel being aligned with the fourth light detector.

6. The apparatus of claim 5, wherein the fourth light source emits one or more ultra-violet wavelengths of light.

7. The apparatus of claim 5, further comprising:
a first pair of filters positioned along the first fluorescence channel;
a second pair of filters positioned along the second fluorescence channel;
a third pair of filters positioned along the third fluorescence channel; and
a fourth pair of filters positioned along the fourth fluorescence channel.

8. The apparatus of claim 7, wherein each pair of the first through fourth pairs of filters includes an excitation filter positioned along a respective incoming light channel and an emission filter positioned along a respective outgoing light channel.

9. The apparatus of claim 1, wherein the sub-housing is formed by three-dimensional printing.

10. The apparatus of claim 9, wherein the sub-housing is formed of thermoplastic.

11. The apparatus of claim 10, wherein the sub-housing is monolithic.

12. An apparatus for performing spectrophotometry and fluorescence measurements on one or more samples, the apparatus comprising:
a first sample site for performing the spectrophotometry measurements on a first sample;
a second sample site for performing the fluorescence measurements on a second sample; and
a sub-housing at least partially surrounding the second sample site, the sub-housing including at least three fluorescence channels aligned with the second sample site for performing at least three fluorescence measurements of at least three different wavelengths of light on the second sample, each fluorescence channel including an incoming light channel and an outgoing light channel orthogonal to the incoming light channel at the second sample site.

13. The apparatus of claim 12, wherein the at least three fluorescence channels include four fluorescence channels aligned with the second sample, the apparatus further comprising:
four light sources, each of the four light sources being aligned with a respective incoming light channel; and
four light detectors, each of the four light detectors being aligned with a respective outgoing light channel,
wherein the apparatus is configured to measure fluorescence of the second sample using the four light sources and the four light detectors.

14. The apparatus of claim 12, wherein the second sample site is configured to accept a PCR tube containing the second sample.

15. The apparatus of claim 12, wherein the first sample site includes a first moveable sample surface and a fixed sample surface, and the first sample is a microvolume sample.

16. The apparatus of claim 12, wherein the first sample site is configured to accept a container holding the first sample.

17. The apparatus of claim 12, further comprising:
a third sample site for performing the spectrophotometry measurements on a third sample.

18. The apparatus of claim 17, wherein the first sample site includes a first moveable sample surface and a fixed sample surface, and the first sample is a microvolume sample, and wherein the third sample site is configured to accept a container holding the third sample.

19. A method of measuring the fluorescence of a sample comprising:
transmitting light from a first light source down a first incoming light channel of an apparatus toward the sample;
measuring light emitted from the sample down a first outgoing light channel in response to the light from the first light source;
transmitting light from a second light source down a second incoming light channel of the apparatus toward the sample;
measuring light emitted from the sample down a second outgoing light channel in response to the light from the second light source;
transmitting light from a third light source down a third incoming light channel of the apparatus toward the sample; and
measuring light emitted from the sample down a third outgoing light channel in response to the light from the third light source.

20. The method of claim 19, wherein the light from the first light source is red light, the light from the second light source is blue light, and the light from the third light source is green light.

21. The method of claim 19, further comprising:
transmitting light from a fourth light source down a fourth incoming light channel of the apparatus toward the sample; and
measuring light emitted from the sample down a fourth outgoing light channel in response to the light from the fourth light source.

22. The method of claim 21, wherein the light from the fourth light source is ultra-violet light.

23. The method of claim 22, wherein the first light source, the second light source, the third light source, and the fourth light source transmit light consecutively.
